(19) United States
(12) Patent Application Publication
(10) Pub. No.: US 2006/0092095 A1
(43) Pub. Date: May 4, 2006

(54) Multi-display system

(75) Inventors: Chen Ming-Daw, Hsinchu City (TW); Huang Jih-Fon, Zhubei City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/000,074

(22) Filed: Dec. 1, 2004

(30) Foreign Application Priority Data
Nov. 2, 2004 (TW) 93133279

(51) Int. Cl. G09G 5/00

(52) U.S. Cl. 345/1.3

(57) ABSTRACT

The present invention discloses a multi-display system, comprising: a system circuit device, having a circuit layout disposed thereon; a main flexible circuit device, electrically connected to the system circuit device; and at least a display device, electrically connected to the main flexible circuit device. Moreover, the display device further comprises: a main panel, electrically connected to the main flexible circuit device; at least an auxiliary flexible circuit device, electrically connected to the main panel; at least an auxiliary panel group, electrically connected to the auxiliary flexible circuit device; at least a data driver; and at least a scan driver; wherein one of the data drivers is optionally connected to a device selected from the group consisting of the auxiliary panel group and another data driver connecting to the auxiliary panel group; and one of the scan drivers is optionally connected to a device selected from the group consisting of the auxiliary panel group and another scan driver connecting to the auxiliary panel group.

### FIELD OF THE INVENTION

The present invention relates to a multi-display system, and more particularly, to a system with multiple display panels having a driver circuit shared by the main panel and sub-panels thereof.

### BACKGROUND OF THE INVENTION

Currently, flat panel displays are commonly used in many applications, such as computer, cellular phone, TV, digital camera, digital camcorder, watch, instrument panel for automobile, and billiard boards of various sizes, etc. Among those applications, dual-panel display or multi-panel display are quite popular recently, e.g. most of the folding cellular phones adopt dual-panel display for displaying simple information on the sub-panel thereof and major content on the main panel thereof.

Refer to FIG. 1A, which is a schematic view showing a multi-display system of prior art. As seen in FIG. 1A, the multi-display system comprises: a main panel 11b, being connected to a system circuit board 11 by a flexible printed circuit board (FPC) 112; and a sub-panel 11a, being connected to the system circuit board 11 by another flexible printed circuit board (FPC) 111; wherein the multi-display system of FIG. 1 is characterized in that: (1) the sub-panel 11a is not directly connected to the main panel 11b, that is, the FPC 111 connecting the sub-panel 11a is separated from the FPC 112 connecting the main panel 11b that both are connected to the system circuit board 11 in respective; (2) the main panel 11a is equipped with a data driver IC and a scan driver IC which are independent to another data driver IC and scan driver IC for driving the sub-panel 11a, that is, two set of driving devices, each consisting of a data driver IC and a scan driver IC, are required and are functioned separately and independently to output images to the main panel 11b and the sub-panel 11a in respective.

Similarly, as seen in FIG. 1B, four sub-panels 12a, 12b, 12d, and 12e and two main panels 12c and 12f are connected to a system circuit board 12 respectively and independently by FPCs 121, 122, 123, 124, and 125, that each display panel will have a set of driving device consisting of a data driver IC and a scan driver IC for driving the same, and each set of driving device is independent to each other.

Therefore, in a conventional multi-display system, each display panel will have its own wiring connecting the same to the system circuit board and independent driving device for driving the same, such that the device using the conventional multi-display system will have complex internal circuitry causing the device to be bulky and costly. By virtue of this, a multi-display system of simplified circuit layout is in great demand.

### SUMMARY OF THE INVENTION

It is the primary object of the invention to provide a multi-display system having data driver ICs and scan driver ICs shared or partially shared by the main panel and sub-panels thereof.

It is another object of the invention to provide a multi-display system, capable of connecting at least two display panels electrically by way of a plurality of flexible circuit devices like FPCs so as to shorten the circuit layout of the system and reduce manufacturing cost.

To achieve the aforesaid objects, the present invention provides a multi-display system, comprising: a system circuit device, having a circuit layout disposed thereon; a main flexible circuit device, electrically connected to the system circuit device; and at least a display device, electrically connected to the main flexible circuit device.

The display device further comprises: a main panel, electrically connected to the main flexible circuit device; at least an auxiliary flexible circuit device, electrically connected to the main panel; at least an auxiliary panel group, electrically connected to the auxiliary flexible circuit device; at least a data driver; and at least a scan driver; wherein one of the data drivers is optionally connected to a device selected from the group consisting of the auxiliary panel group and another data driver connecting to the auxiliary panel group; and one of the scan drivers is optionally connected to a device selected from the group consisting of the auxiliary panel group and another scan driver connecting to the auxiliary panel group.

In a preferred embodiment of the invention, the auxiliary panel group is a single sub-panel, electrically connected to the auxiliary flexible circuit device.

,In another preferred embodiment of the invention, the auxiliary panel group is consisted of at least two sub-panels and at least a subsidiary flexible circuit device, electrically connected to the sub-panels, wherein one of the plural sub-panels is electrically connected to the auxiliary flexible circuit device directly, and the other sub-panels are electrically connected to the directly-connected sub-panel by way of the subsidiary flexible circuit device.

In addition, the data driver is arranged at a side of the main panel, and similarly the scan driver can also be arranged at a side of the main panel.

It is preferred that the multi-display system further comprises a timing controller, electrically connected to the main panel. Moreover, the timing controller is substantially an application-specific integrated circuit (ASIC), and the data drivers and the scan drivers can be integrated into one ASIC. Besides, the main flexible circuit device can be a flexible printed circuit board (FPC) and the auxiliary flexible circuit device can be a flexible printed circuit board (FPC).

In a preferred embodiment of the invention, the main panel of the multi-display system is a display selected from the group consisting of organic light emitting display (OLED), passive matrix liquid crystal display (PM-LCD), active matrix liquid crystal display (AM-LCD), low temperature poly silicon liquid crystal display (LTPS-LCD), reflective display and reflective liquid crystal display. Moreover, the sub-panels of the auxiliary panel group are at least a display selected from the group consisting of organic light emitting display (OLED), passive matrix liquid crystal display (PM-LCD), active matrix liquid crystal display (AM-LCD), low temperature poly silicon liquid crystal display (LTPS-LCD), reflective display and reflective liquid crystal display.

Other objects, advantages and novel features of the present invention will become apparent upon study of the remaining portions of the specification and drawings.

### BRIEF DESCRIPTION OF THE DRAWINGS

FIG. 1A is a schematic view showing a multi-display system of prior art

FIG. 1B is a schematic view showing another multi-display system of prior art

FIG. 2 is a schematic view showing a multi-display system according to a preferred embodiment of the present invention.

FIG. 3 is a schematic view showing a multi-display system according to another preferred embodiment of the present invention.

FIG. 4 is a schematic view of a multi-display system having a data driver shared by the display panels thereof according to the present invention.

FIG. 5 is a schematic view of a multi-display system having a scan driver shared by the display panels thereof according to the present invention.

FIG. 6A is a functional block diagram showing a dual screen display of prior art.

FIG. 6B is a functional block diagram showing a dual-display system of the invention.

FIG. 7A is a schematic illustration of a preferred embodiment of the invention.

FIG. 7B is a schematic illustration of another preferred embodiment of the invention.

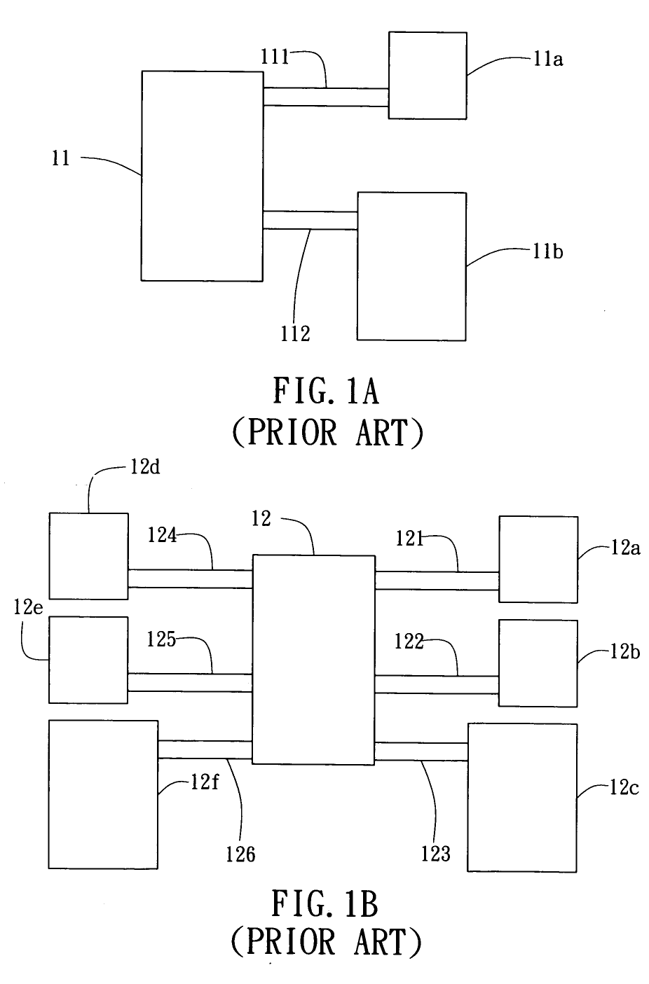

### DESCRIPTION OF THE PREFERRED EMBODIMENT

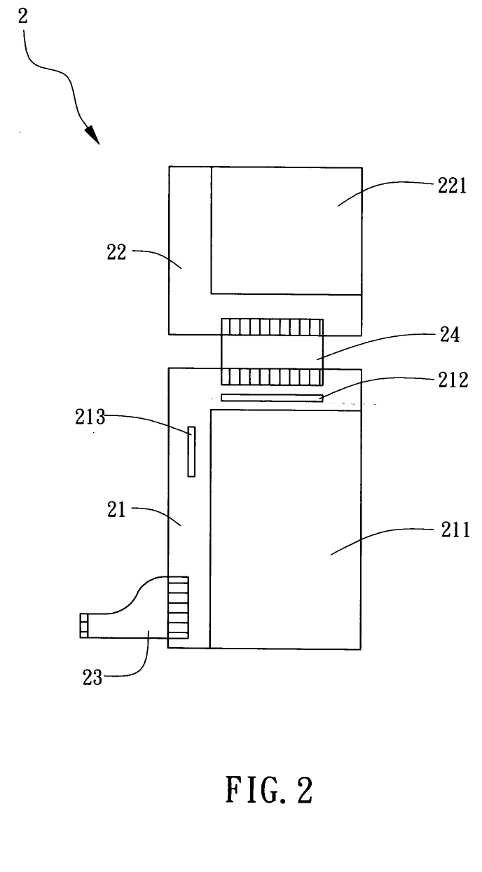

Please refer to FIG. 2, which is a schematic view showing a multi-display system according to a preferred embodiment of the present invention. The multi-display system 2 of FIG. 2 comprises a main panel 21, a sub-panel 22, two flexible printed circuit boards (FPCs) 23 and 24. Wherein, the main panel 21 is electrically connected to the FPC 23 by outer lead bonding (OLB), and the FPC 23 is electrically connected to a system circuit board (not shown) such that the main panel 21 is enabled to receive electrical data from the FPC 23.

The main panel 21 further comprises a display area 211 and two drivers 212, 213 arranged thereon, wherein the driver 212 acted as a data driver is capable of operating cooperatively with the driver 213 acted as a scan driver for enabling the display area 211 to display images.

The main panel 21 is further electrically connected to the FPC 24 by outer lead bonding (OLB), and the FPC 24 is further electrically connected to the sub-panel 22, such that the sub-panel 22 having a display area 221 can also be driven by the two drivers 212 and 213 for enabling the display area 221 to display images.

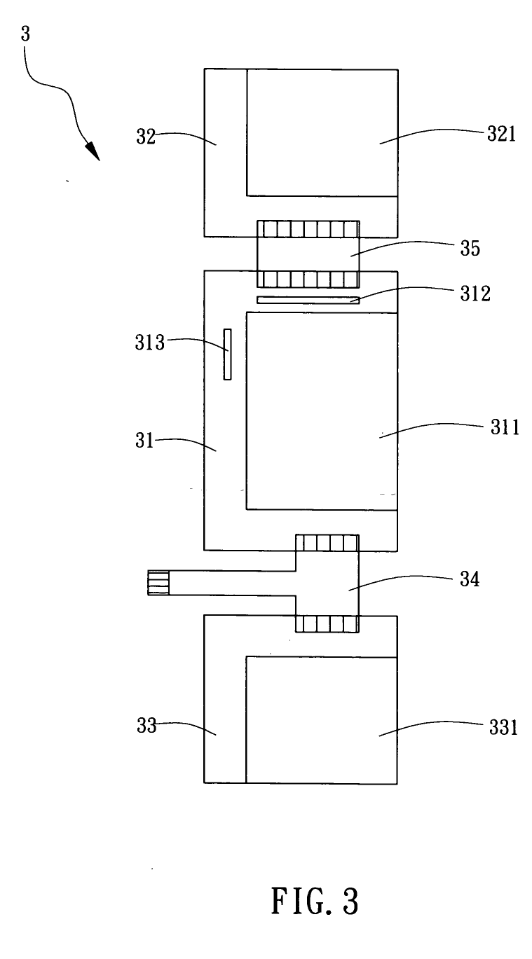

Please refer to FIG. 3, which is a schematic view showing a multi-display system according to another preferred embodiment of the present invention. The multi-display system 3 of FIG. 3 comprises a main panel 31, two sub-panels 32, 33, two FPCs 34, 35. Wherein, the main panel 31 is electrically connected to the FPC 34 by outer lead bonding (OLB), and the FPC 34 is electrically connected to a system circuit board (not shown) such that the main panel 31 is enabled to receive electrical data from the FPC 34.

The main panel 31 further comprises a display area 311 and two drivers 312, 313 arranged thereon, wherein the driver 312 acted as a data driver is capable of operating cooperatively with the driver 313 acted as a scan driver for enabling the display area 311 to display images.

The main panel 31 is further electrically connected to the FPC 35 by outer lead bonding (OLB), and the FPC 35 is further electrically connected to the sub-panel 32, such that the sub-panel 32 having a display area 321 can also be driven by the two drivers 312 and 313 for enabling the display area 321 to display images.

Moreover, the FPC 34 is further electrically connected to the sub-panel 33 such that the sub-panel 33 having a display area 331 can also be driven by the two drivers 312 and 313 for enabling the display area 331 to display images.

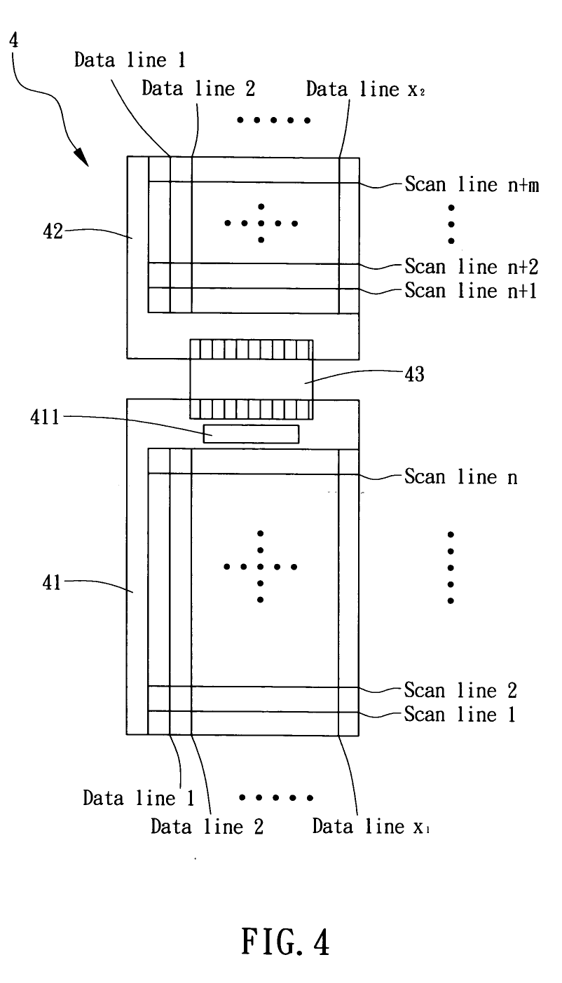

Please refer to FIG. 4, which is a schematic view of a multi-display system having a data driver shared by the display panels thereof according to the present invention. The multi-display system 4 of FIG. 4 comprises a main panel 41, a sub-panel 42, and a FPC 43, wherein the main panel 41 is electrically connected to the FPC 43, and the FPC 43 is electrically connected to the sub-panel 42. In addition, the main panel 41 is composed of x₁ data lines (i.e. data line 1, data line 2, . . . , and data line x₁ in respective) and n scan lines (i.e. scan line 1, scan line 2, . . . , and scan line n in respective) and has a data driver 411 arranged therein; and the sub-panel 42 is composed of x₂ data lines (i.e. data line 1, data line 2, . . . , and data line x₂ in respective) and m scan lines (i.e. scan line n+1, scan line n+2, . . . , and scan line n+m in respective).

As seen in FIG. 4, while x₁≧x₂ and using the electrical connection provided by the FPC 43, the data driver 411 not only is capable of driving the x₁ data lines of the main panel 41, but also is capable of driving the x₂ data lines of the sub-panel 42 simultaneously. However, while x₁<x₂, the data driver 411 can drive all x₁ data lines of the main panel 41 and partial data lines of the sub-panel 42, that is, x₁ out of x₂ data lines of the sub-panel 42, and the excess data lines of the sub-panel, i.e. the remaining x₂−x₁ data lines, is driven by another data driver (not shown) arranged either in the main panel 41 or the sub-panel 42.

In order to use the same data driver 411 for driving all data lines, the scan lines are sequentially aligned from the main panel 41 to the sub-panel 42, that is, sequentially arranging the scan lines from scan line 1, scan line 2, . . . , scan line n, scan line n+1, scan line n+2 . . . , scan line n+m, or vice versa, and the main panel 41 is controlled by a generated shift clock (not shown). Moreover, the main panel 41 and sub-panel 42 use different scan drivers (not shown), where the scan drivers can be an integrated circuit (IC) or can be a device integrally manufactured on the substrate of the main panel or sub-panel by LTPS.

In addition, the data driver 411 can be an IC or can be a device integrally manufactured on the substrate of the main panel or sub-panel by LTPS. The multi-display system 4 further comprises a timing controller, which can be integrated with the data driver 411.

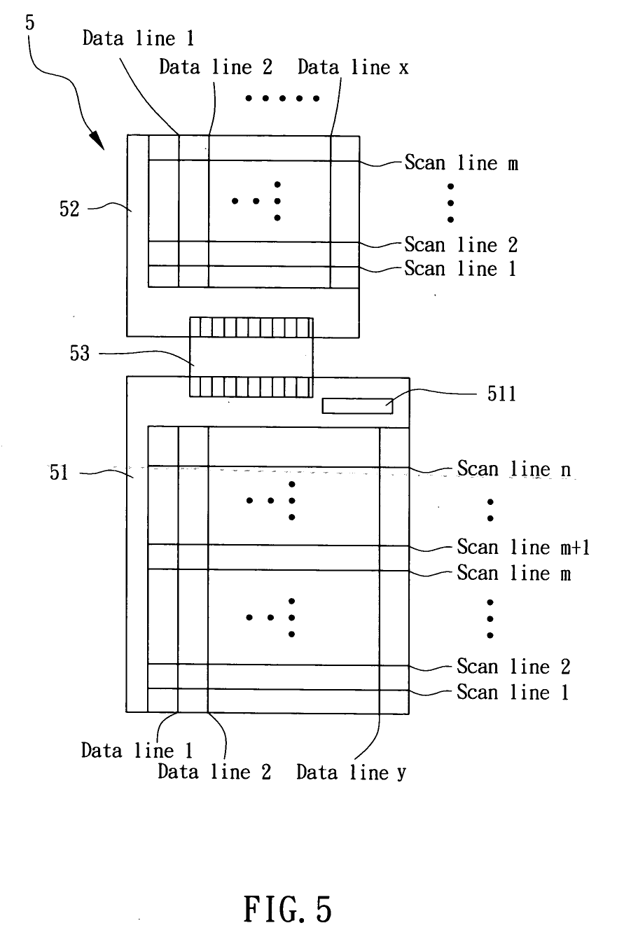

Please refer to FIG. 5, which is a schematic view of a multi-display system having a scan driver shared by the display panels thereof according to the present invention. The multi-display system 5 of FIG. 5 comprises a main panel 51, a sub-panel 52, and a FPC 53, wherein the main panel 51 is electrically connected to the FPC 53, and the FPC 53 is electrically connected to the sub-panel 52. In addition, the main panel 51 is composed of x data lines (i.e. data line 1, data line 2, . . . , and data line x in respective) and n scan lines (i.e. scan line 1, scan line 2, . . . , and scan line n in respective) and has a scan driver 511 arranged therein; and the sub-panel 52 is composed of y data lines (i.e. data line 1, data line 2, . . . , and data line y in respective) and m scan lines (i.e. scan line 1, scan line 2, . . . , and scan-line m in respective).

As seen in FIG. 5, while n≧m and using the electrical connection provided by the FPC 53, the scan driver 511 not only is capable of driving then scan lines of the main panel 51, but also is capable of driving the m scan lines of the sub-panel 52 simultaneously. Moreover, the main panel 51 and sub-panel 52 use different data drivers (not shown), where the data drivers can be an integrated circuit (IC) or can be a device integrally manufactured on the substrate of the main panel or sub-panel by LTPS.

In addition, the data drive can be mounted on the FPC 53 or integrally manufactured on the substrate of the main panel or sub-panel by LTPS. The multi-display system 5 further comprises a timing controller, which can be integrated with the data driver 511.

As seen in FIG. 5, since the main panel 51 and the sub-panel 52 use different data drivers in respective, the data driver of the sub-panel 52 can be disposed on the sub-panel so as to minimize the layout requirement of wiring.

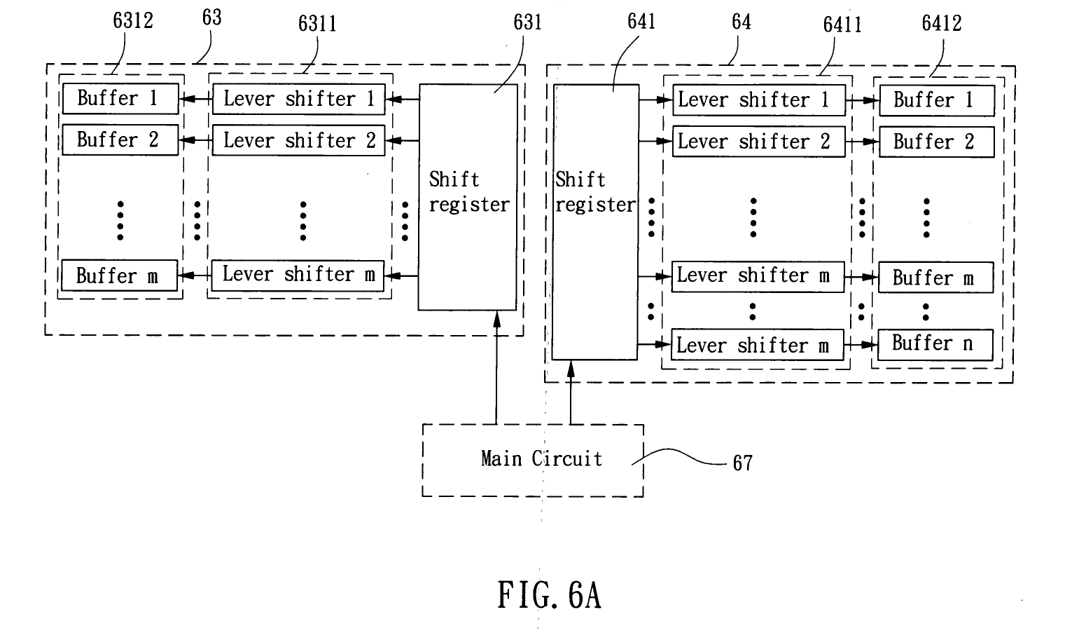

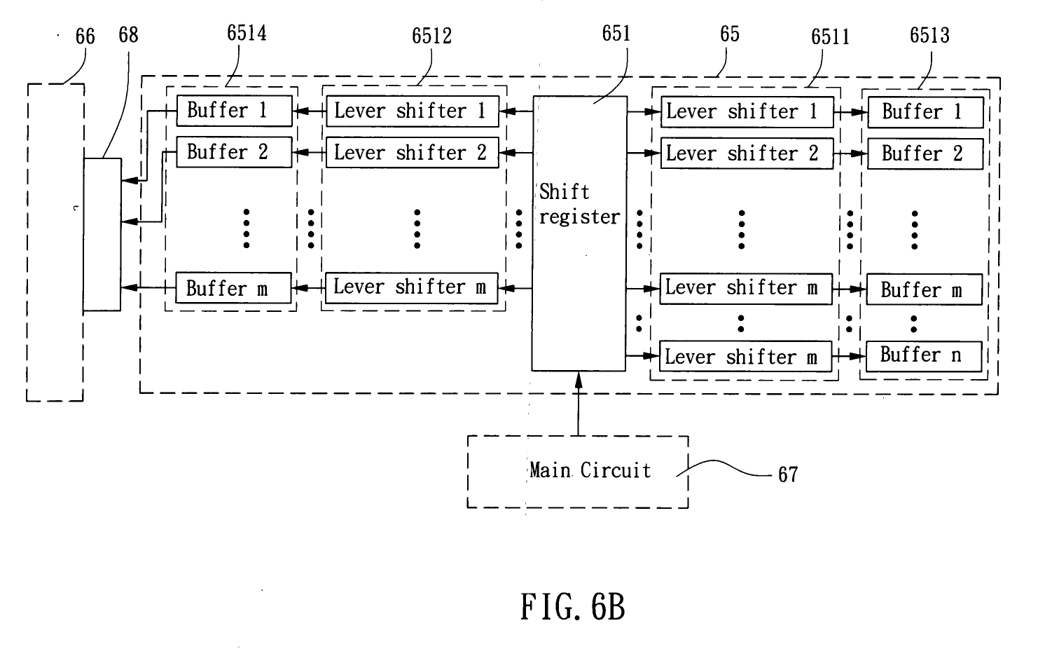

Please refer to FIG. 6A, which is a functional block diagram showing a dual screen display of prior art. As seen in FIG. 6A, two shift registers 631 and 641 respectively arranged in two display panels 63 and 64 receive different electrical data separately from a main system circuit 67, and then the level of the electrical data received by each shift register is raised by the corresponding level shifter units 6311 and 6411 in respective so that the level-raised electrical data are sent to the corresponding buffer units 6312 and 6412 in respective for driving the corresponding display panels 63 and 64.

Please refer to FIG. 6B, which is a functional block diagram showing a dual-display system of the invention. As seen, the main panel 65 is electrically connected to a FPC 68, and the FPC 68 is electrically connected to a sub-panel 66. Moreover, there is only a single shift register 651 arranged in the main panel 65, such that a single electrical data is received by the single shift register 651, and then the received data is sent separately to the two level shifter units 6511 and 6512 for raising the level thereof, and then the level-raise electrical data of the level shifter unit 6511 is sent to the buffer unit 6513 for driving the main panel 65 and the level-raise electrical data of the level shifter unit 6512 is sent to the buffer unit 6514 to be further transmitted by way of the FPC 68 for driving the sub-panel 66. While n≧m, the electrical data of the level shifter 1 of the level shifter unit 6511 is shared by the level shifter 1 of the level shifter unit 6512, and the electrical data of the level shifter 2 of the level shifter unit 6511 is shared by the level shifter 2 of the level shifter unit 6512, and so forth, i.e. the electrical data of the first m level shifter of the level shifter unit 6511 is identical to those of the corresponding m level shifters of the level shifter unit 6512. In this regard, the sub-panel 66 can be driven by way of the transmission of the FPC 68 such that the amount of devices arranged on the sub-panel 66 is reduced and simplified, and also enable the sub-panel 66 to be made of a cheaper material like a-Si. Vice versa, the main panel 65 can be driven by the sub-panel 66 having the single shift register 651 arranged thereon for reducing the amount of devices arranged on the main panel 65. In a preferred embodiment, the data driver can be arranged on the main panel 65 and the scan driver can be arranged on the sub-panel 66 that the data driver and the scan driver are enabled to work cooperatively, or vice versa,

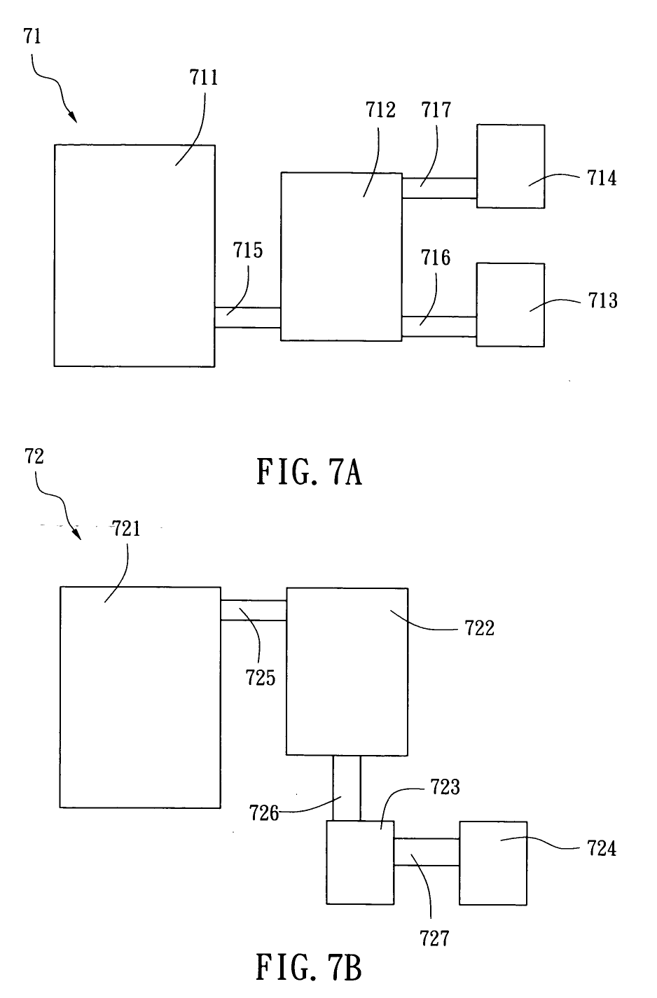

Please refer to FIG. 7A, which is a schematic illustration of a preferred embodiment of the invention. The multi-display system 71 comprises a system circuit board 711, a main panel 712, two sub-panels 713, 714, wherein the system circuit board 711 is electrically connected to the main panel 712 and the two sub-panels 713, 714 respectively by three flexible printed circuit boards 715, 716 and 727.

Please refer to FIG. 7B, which is a schematic illustration of another preferred embodiment of the invention. The multi-display system 72 comprises a system circuit board 721, a main panel 722, two sub-panels 723, 724, wherein the system circuit board 721 is electrically connected to the main panel 722 and the sub-panel 723 respectively by three flexible printed circuit boards 725, 726, and the sub-panel 723 is further connected to the sub-panel 724 by a flexible printed circuit board 717.

In view of the above description, the multi-display system of the invention has advantages list as following:
(a) Every signal transmitted between the main system circuit board and the sub-panels will pass through the main panel;
(b) The driving device including data drivers and scan drivers can be arranged either only in the main panel, or only in any one of the sub-panels, or partially in the main panel and partially in the sub-panel.
(c) The main panel and the sub-panels can adopt different type of display, such as organic light emitting display (OLED), passive matrix liquid crystal display (PM-LCD), low temperature poly silicon liquid crystal display (LTPS-LCD), reflective display and reflective liquid crystal display.
(d)The main panel can be used to drive a plurality of sub-panels by the proper connection formed therebetween using a plurality of flexible printed circuit boards, since the driving circuit is integrally formed on the glass substrate of the main panel while manufacturing the same by LTPS.
(e) There are a plurality of variations for connecting more than three display panels, as seen in FIG. 7A and 7B.

It is preferred that the multi-display system further comprises a timing controller, electrically connected to the main panel. Moreover, the timing controller is substantially an application-specific integrated circuit (ASIC), and the data drivers and the scan drivers can be integrated into one ASIC. Besides, while data driver and/or scan driver are shared, the main panel is manufactured by LTPS and the sub-panels are manufactured using technology of amorphous silicon (a-Si). Moreover, the data lines and/or scan lines of the sub-panels can adopt multiplexer design (MUX) to reduce the wire on FPC/glass.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A multi-display system, comprising:
a system circuit device, having a circuit layout disposed thereon;
a main flexible circuit device, electrically connected to the system circuit device; and
at least a display device, electrically connected to the main flexible circuit device, the display device further comprising:
a main panel, electrically connected to the main flexible circuit device;
at least an auxiliary flexible circuit device, electrically connected to the main panel;
at least an auxiliary panel group, electrically connected to the auxiliary flexible circuit device;
at least a data driver, each data driver being capable of optionally connecting to a device selected from the group consisting of the auxiliary panel group and another data driver connecting to the auxiliary panel group; and
at least a scan driver, each scan driver being capable of optionally connecting to a device selected from the group consisting of the auxiliary panel group and another scan driver connecting to the auxiliary panel group;

2. The system as recited in claim 1, wherein the auxiliary panel group is substantially a single sub-panel electrically connected to the auxiliary flexible circuit device.

3. The system as recited in claim 1, wherein the auxiliary panel group comprises:
at least two sub-panels; and
at least a subsidiary flexible circuit device;
wherein one of the plural sub-panels is electrically connected to the auxiliary flexible circuit device directly, and the other sub-panels are electrically connected to the directly-connected sub-panel by way of the corresponding subsidiary flexible circuit device.

4. The system as recited in claim 1, wherein the data drivers are arranged at a side of the main panel.

5. The system as recited in claim 1, wherein the scan drivers are arranged at a side of the main panel.

6. The system as recited in claim 1, further comprising a timing controller, electrically connected to the main panel.

7. The system as recited in claim 6, wherein the timing controller is an application-specific integrated circuit (ASIC).

8. The system as recited in claim 1, wherein the data drivers and the scan drivers are integrated into an application-specific integrated circuit (ASIC).

9. The system as recited in claim 1, wherein the main flexible circuit device is a flexible printed circuit board (FPC).

10. The system as recited in claim 1, wherein the auxiliary flexible circuit device is a flexible printed circuit board (FPC).

11. The system as recited in claim 1, wherein the main panel is a display selected from the group consisting of organic light emitting display (OLED), passive matrix liquid crystal display (PM-LCD), active matrix liquid crystal display (AM-LCD), low temperature poly silicon liquid crystal display (LTPS-LCD), reflective display and reflective liquid crystal display.

12. The system as recited in claim 1, wherein each sub-panel of the auxiliary panel group is a display selected from the group consisting of organic light emitting display (OLED), passive matrix liquid crystal display (PM-LCD), active matrix liquid crystal display (AM-LCD), low temperature poly silicon liquid crystal display (LTPS-LCD), reflective display and reflective liquid crystal display.
